(19) United States
(12) Patent Application Publication
(10) Pub. No.: US 2025/0218114 A1
(43) Pub. Date: Jul. 3, 2025

(54) INTERPOLATED TRANSLATABLE AUDIO FOR VIRTUAL EXPERIENCE

(71) Applicant: Roblox Corporation, San Mateo, CA (US)

(72) Inventors: Palmer Noel Hogen, Glendale, CA (US); Addison Polcyn, San Francisco, CA (US); Frederick William Umminger, III, Oakland, CA (US); Matthew Zhang, San Mateo, CA (US)

(73) Assignee: Roblox Corporation, San Mateo, CA (US)

(21) Appl. No.: 18/588,887

(22) Filed: Feb. 27, 2024

Related U.S. Application Data
(60) Provisional application No. 63/616,720, filed on Dec. 31, 2023.

(51) Int. Cl. G06T 17/00; G06F 3/16

(52) U.S. Cl. CPC G06T 17/00; G06F 3/16

(57) ABSTRACT

According to one aspect, a method of audio-signal processing of a network device is described. The method may include obtaining an audio portion associated with a sound field of an avatar at an initial position in a virtual experience. The method may include identifying at least one interpolation region associated with the avatar at the initial position or associated with the avatar at one or more subsequent positions. The method may include sampling an audio mix for a plurality of points of the at least one interpolation region based on the audio portion associated with the sound field of the avatar at the initial position or associated with the sound field of the avatar at the one or more subsequent positions. The method may include transmitting an audio packet associated with the audio mix to a client device.

### CROSS-REFERENCE TO RELATED APPLICATIONS

This application claims priority to U.S. Provisional Application No. 63/616,720, entitled “Interpolated Translatable Audio for Virtual Experience,” filed on Dec. 31, 2023, the content of which is incorporated herein in its entirety.

### TECHNICAL FIELD

Embodiments relate generally to online virtual experience platforms, and more particularly, to methods, systems, and computer readable media for interpolated translatable audio.

### BACKGROUND

Online platforms, such as virtual experience platforms and online gaming platforms, can perform audio mixing for a client device at one or more cloud server(s).

For example, some gaming networks perform audio mixing of a sound field (e.g., that is made up of sound sources that include other avatars and/or objects in a virtual environment) at one or more cloud server(s). This can potentially allow for many more simultaneous in-game sounds than can be produced on a client device. For instance, this may allow an audio mix for thousands of voice-activated users with thousands of sound emitters.

However, one challenge of mixing and sending audio over the network is the unavoidable latency. For instance, in the time that it takes for a completed audio mix to reach the client device from the cloud server, the client device's avatar may have moved to a new listening position. Consequently, by the time the client device outputs the received audio, the avatar and the sound emitters (e.g., other avatars or objects) may occupy different relative positions. This may cause audio output to the listener to be noticeably wrong, thereby degrading the quality of the immersive experience.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Aspects of this disclosure are directed to methods, systems, and computer-readable media for audio-signal processing.

According to one aspect, a method of audio-signal processing of a network device is described. The method may include obtaining, by a processor of the network device, an audio portion associated with a sound field of an avatar at an initial position in a virtual experience at a first time. The method may include identifying, by the processor, at least one interpolation region associated with the avatar at the initial position in the virtual experience at the first time or associated with the avatar at one or more subsequent positions at a second time. The second time may be later than the first time. The method may include sampling, by the processor, an audio mix for a plurality of points of the at least one interpolation region based on the audio portion associated with the sound field of the avatar at the initial position in the virtual experience at the first time or associated with the sound field of the avatar at the one or more subsequent positions at the second time. The method may include transmitting, by the processor, an audio packet associated with the audio mix to a client device.

In some implementations, the method may include predicting, by the processor, the one or more subsequent positions of the avatar in the virtual experience at the second time.

In some implementations, predicting the one or more subsequent positions of the avatar is performed based on at least one of a dead-reckoning operation, an input-based prediction operation, a game-logic based operation, a Kalman filter, a linear extrapolation, or a machine-learning model.

In some implementations, the one or more subsequent positions may include a first subsequent position and a second subsequent position both associated with the second time. In some implementations, the at least one interpolation region may include a first interpolation region associated with the first subsequent position and a second interpolation region associated with the second subsequent position.

In some implementations, sampling the audio mix for the plurality of points of the interpolation region based on the audio portion associated with the sound field of the avatar at the initial position in the virtual experience at the first time or associated with the sound field of the avatar at the one or more subsequent positions at the second time may include sampling, by the processor, a first regional audio mix for the plurality of points based the first interpolation region associated with the first subsequent position. In some implementations, sampling the audio mix for the plurality of points of the interpolation region based on the audio portion associated with the sound field of the avatar at the initial position in the virtual experience at the first time or associated with the sound field of the avatar at the one or more subsequent positions at the second time may include sampling, by the processor, a second regional audio mix for the plurality of points based on the second interpolation region associated with the second subsequent position.

In some implementations, the first regional audio mix may include a first plurality of audio channels associated with the first subsequent position. In some implementations, the second regional audio mix may include a second plurality of audio channels associated with the second subsequent position.

In some implementations, the method may include generating, by the processor, the audio packet based on the first regional audio mix and the second regional audio mix.

According to another aspect of the present disclosure, a method of audio-signal processing by a client device is provided. The method may include receiving, by a processor of the client device, a first audio mix sampled for a plurality of points of at least one interpolation region based on an audio portion associated with a sound field of an avatar at an initial position in a virtual experience at a first time or associated with a sound field of the avatar at one or more subsequent positions at a second time. The method may include interpolating, by the processor, the first audio mix sampled for the plurality of points of the at least one interpolation region to obtain a second audio mix associated with a final position of the avatar in the virtual experience at the second time. The method may include outputting, by the processor, audio that corresponds to a subsequent sound field of the avatar at the final position in the virtual experience at the second time based on the second audio mix.

In some implementations, the one or more subsequent positions include a first subsequent position and a second subsequent position. In some implementations, the first audio mix may include a first regional audio mix associated with a first interpolation region associated with the first subsequent position and a second regional audio mix associated with a second interpolation region associated with a second subsequent position.

In some implementations, the method may include comparing, by the processor, the final position of the avatar in the virtual experience with the first subsequent position and the second subsequent position. In some implementations, the method may include identifying, by the processor, whether the first subsequent position or the second subsequent position is closer to the final position of the avatar. In some implementations, the method may include, in response to the first subsequent position being closer to the final position, selecting, by the processor, the first regional audio mix for use in interpolating. In some implementations, the method may include, in response to the second subsequent position being closer to the final position, selecting, by the processor, the second regional audio mix for use in interpolating.

According to a further aspect of the present disclosure a non-transitory computer-readable medium storing instructions for a network device is provided. The instructions, which when executed by a processor of the network device, cause the processor to perform operations. The operations may include obtaining an audio portion associated with a sound field of an avatar at an initial position in a virtual experience at a first time. The operations may include identifying at least one interpolation region associated with the avatar at the initial position in the virtual experience at the first time or associated with the avatar at one or more subsequent positions at a second time. The second time may be later than the first time. The operations may include sampling an audio mix for a plurality of points of the at least one interpolation region based on the audio portion associated with the sound field of the avatar at the initial position in the virtual experience at the first time or associated with the sound field of the avatar at the one or more subsequent positions at the second time. The operations may include transmitting an audio packet associated with the audio mix to a client device.

In some implementations, the operations may include predicting the one or more subsequent positions of the avatar in the virtual experience at the second time.

In some implementations, predicting the one or more subsequent positions of the avatar is performed based on at least one of a dead-reckoning operation, an input-based prediction operation, a game-logic based operation, a Kalman filter, a linear extrapolation, or a machine-learning model.

In some implementations, the one or more subsequent positions may include a first subsequent position and a second subsequent position both associated with the second time. In some implementations, the at least one interpolation region may include a first interpolation region associated with the first subsequent position and a second interpolation region associated with the second subsequent position.

In some implementations, sampling the audio mix for the plurality of points of the interpolation region based on the audio portion associated with the sound field of the avatar at the initial position in the virtual experience at the first time or associated with the sound field of the avatar at the one or more subsequent positions at the second time may include sampling a first regional audio mix for the plurality of points based the first interpolation region associated with the first subsequent position. In some implementations, sampling the audio mix for the plurality of points of the interpolation region based on the audio portion associated with the sound field of the avatar at the initial position in the virtual experience at the first time or associated with the sound field of the avatar at the one or more subsequent positions at the second time may include sampling a second regional audio mix for the plurality of points based on the second interpolation region associated with the second subsequent position.

In some implementations, the first regional audio mix may include a first plurality of audio channels associated with the first subsequent position. In some implementations, the second regional audio mix may include a second plurality of audio channels associated with the second subsequent position.

In some implementations, the operations may include generating the audio packet based on the first regional audio mix and the second regional audio mix.

According to still another aspect of the present disclosure, a non-transitory computer-readable medium storing instructions for a client device. The operations may include receiving a first audio mix sampled for a plurality of points of at least one interpolation region based on an audio portion associated with a sound field of an avatar at an initial position in a virtual experience at a first time or associated with a sound field of the avatar at one or more subsequent positions at a second time. The operations may include interpolating the first audio mix sampled for the plurality of points of the at least one interpolation region to obtain a second audio mix associated with a final position of the avatar in the virtual experience at the second time. The operations may include outputting audio that corresponds to a subsequent sound field of the avatar at the final position in the virtual experience at the second time based on the second audio mix.

In some implementations, the one or more subsequent positions include a first subsequent position and a second subsequent position. In some implementations, the first audio mix may include a first regional audio mix associated with a first interpolation region associated with the first subsequent position and a second regional audio mix associated with a second interpolation region associated with a second subsequent position.

In some implementations, the operations may include comparing the final position of the avatar in the virtual experience with the first subsequent position and the second subsequent position. In some implementations, the operations may include identifying whether the first subsequent position or the second subsequent position is closer to the final position of the avatar. In some implementations, the operations may include, in response to the first subsequent position being closer to the final position, selecting the first regional audio mix for use in interpolating. In some implementations, the operations may include, in response to the second subsequent position being closer to the final position, selecting the second regional audio mix for use in interpolating.

According to still another aspect of the present disclosure, a system for audio-signal processing of a network device is provided. The system may include a processor and a memory storing instructions. The memory storing instructions, which when executed by a processor of the network device, cause the processor to perform operations. The operations may include obtaining an audio portion associated with a sound field of an avatar at an initial position in a virtual experience at a first time. The operations may include identifying at least one interpolation region associated with the avatar at the initial position in the virtual experience at the first time or associated with the avatar at one or more subsequent positions at a second time. The second time may be later than the first time. The operations may include sampling an audio mix for a plurality of points of the at least one interpolation region based on the audio portion associated with the sound field of the avatar at the initial position in the virtual experience at the first time or associated with the sound field of the avatar at the one or more subsequent positions at the second time. The operations may include transmitting an audio packet associated with the audio mix to a client device.

In some implementations, the operations may include predicting the one or more subsequent positions of the avatar in the virtual experience at the second time.

In some implementations, predicting the one or more subsequent positions of the avatar is performed based on at least one of a dead-reckoning operation, an input-based prediction operation, a game-logic based operation, a Kalman filter, a linear extrapolation, or a machine-learning model.

In some implementations, the one or more subsequent positions may include a first subsequent position and a second subsequent position both associated with the second time. In some implementations, the at least one interpolation region may include a first interpolation region associated with the first subsequent position and a second interpolation region associated with the second subsequent position.

In some implementations, sampling the audio mix for the plurality of points of the interpolation region based on the audio portion associated with the sound field of the avatar at the initial position in the virtual experience at the first time or associated with the sound field of the avatar at the one or more subsequent positions at the second time may include sampling a first regional audio mix for the plurality of points based the first interpolation region associated with the first subsequent position. In some implementations, sampling the audio mix for the plurality of points of the interpolation region based on the audio portion associated with the sound field of the avatar at the initial position in the virtual experience at the first time or associated with the sound field of the avatar at the one or more subsequent positions at the second time may include sampling a second regional audio mix for the plurality of points based on the second interpolation region associated with the second subsequent position.

In some implementations, the first regional audio mix may include a first plurality of audio channels associated with the first subsequent position. In some implementations, the second regional audio mix may include a second plurality of audio channels associated with the second subsequent position.

In some implementations, the operations may include generating the audio packet based on the first regional audio mix and the second regional audio mix.

According to still another aspect of the present disclosure, a non-transitory computer-readable medium storing instructions for a client device. The operations may include receiving a first audio mix sampled for a plurality of points of at least one interpolation region based on an audio portion associated with a sound field of an avatar at an initial position in a virtual experience at a first time or associated with a sound field of the avatar at one or more subsequent positions at a second time. The operations may include interpolating the first audio mix sampled for the plurality of points of the at least one interpolation region to obtain a second audio mix associated with a final position of the avatar in the virtual experience at the second time. The operations may include outputting audio that corresponds to a subsequent sound field of the avatar at the final position in the virtual experience at the second time based on the second audio mix.

In some implementations, the one or more subsequent positions include a first subsequent position and a second subsequent position. In some implementations, the first audio mix may include a first regional audio mix associated with a first interpolation region associated with the first subsequent position and a second regional audio mix associated with a second interpolation region associated with a second subsequent position.

In some implementations, the operations may include comparing the final position of the avatar in the virtual experience with the first subsequent position and the second subsequent position. In some implementations, the operations may include identifying whether the first subsequent position or the second subsequent position is closer to the final position of the avatar. In some implementations, the operations may include, in response to the first subsequent position being closer to the final position, selecting the first regional audio mix for use in interpolating. In some implementations, the operations may include, in response to the second subsequent position being closer to the final position, selecting the second regional audio mix for use in interpolating.

According to yet another aspect, portions, features, and implementation details of the systems, methods, and non-transitory computer-readable media may be combined to form additional aspects, including some aspects which omit and/or modify some or portions of individual components or features, include additional components or features, and/or other modifications; and all such modifications are within the scope of this disclosure.

### BRIEF DESCRIPTION OF DRAWINGS

FIG. 1 is a diagram of an example network environment, in accordance with some implementations.

FIG. 2 is a schematic of an example visualization of an interpolation region for use in audio mixing, in accordance with some implementations.

FIG. 3 is a schematic of an example visualization of avatar-location prediction for use in audio mixing, in accordance with some implementations.

FIG. 4 is a schematic of an example visualization of an example region shape for use in audio mixing, in accordance with some implementations.

FIG. 5 is a flowchart of an example method to generate an audio mix by a network device, in accordance with some implementations.

FIG. 6 is a flowchart of an example method to generate an audio mix by a client device, in accordance with some implementations.

FIG. 7 is a block diagram illustrating an example computing device, in accordance with some implementations.

### DETAILED DESCRIPTION

In the following detailed description, reference is made to the accompanying drawings, which form a part hereof. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “some implementations”, “an implementation”, “an example implementation”, etc. indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, such feature, structure, or characteristic may be effected in connection with other implementations whether or not explicitly described.

Features described herein provide spatialized audio for output at client devices connected to an online platform, such as, for example, an online experience platform or an online-gaming platform. The online platform may provide a virtual metaverse having a plurality of metaverse places associated therewith. Virtual avatars associated with users can traverse and interact with the metaverse places, as well as items, characters, other avatars, and objects within the metaverse places. The avatars can move from one metaverse place to another metaverse place, while experiencing spatialized audio that provides an immersive and enjoyable experience. Spatialized audio streams from a plurality of users (e.g., or avatars associated with a plurality of users) and/or objects can be prioritized based on many factors, such that rich audio can be provided while taking into consideration position, velocity, movement, and actions of avatars and characters, as well as network bandwidth, processing, and/or other capabilities of the client devices.

Through prioritizing and combining different audio streams, a combined spatialized audio stream can be provided for output at a client device that provides a rich user experience, reduced number of computations for providing the spatialized audio, as well as reduced bandwidth while not detracting from the virtual, immersive experience. Additionally, a spatial audio application programming interface (API) is defined that enables users and developers to implement spatialized audio for almost any online experience, thereby allowing production of high quality online virtual experiences, games, metaverse places, and other interactions that have immersive audio while requiring reduced technical proficiency of users and developers.

Online experience platforms and online gaming platforms (also referred to as “user-generated content platforms” or “user-generated content systems”) offer a variety of ways for users to interact with one another. For example, users of an online experience platform may create games or other content or resources (e.g., characters, graphics, items for game play and/or use within a virtual metaverse, etc.) within the online platform.

Users of an online experience platform may work together towards a common goal in a metaverse place, game, or in game creation; share various virtual items (e.g., inventory items, game items, etc.), engage in audio chat (e.g., spatialized audio chat), send electronic messages to one another, and so forth. Users of an online experience platform may interact with others and play games, e.g., including characters (avatars) or other game objects and mechanisms. An online experience platform may also allow users of the platform to communicate with each other. For example, users of the online experience platform may communicate with each other using voice messages (e.g., via voice chat with spatialized audio), text messaging, video messaging (e.g., including spatialized audio), or a combination of the above. Some online experience platforms can provide a virtual three-dimensional environment or multiple environments linked within a metaverse, in which users can interact with one another or play an online game.

In order to enhance the value of an online experience platform, the platform may be designed to provide rich audio for playback at a user device. The audio can include, for example, different audio streams from different users, as well as background audio. According to various implementations described herein, the different audio streams can be transformed into spatialized audio streams. The spatialized audio streams may be combined, for example, to provide a combined spatialized audio stream for playback at a client device. Furthermore, prioritized audio streams may be provided such that bandwidth is reduced while still providing immersive, spatialized audio. Moreover, background audio streams may be combined with the spatialized audio, such that realistic background noise/effects are also played back to users. Even further, characteristics of a metaverse place, such as surrounding mediums (air, water, other, etc.), reverberations, reflections, aperture sizes, wall density, ceiling height, doorways, hallways, object placement, non-player objects/characters, and other characteristics are utilized in creating the spatialized audio and/or the background audio to increase realism and immersion within the online virtual experience.

To overcome these and other challenges, the present disclosure provides techniques that construct an audio format by sampling the audio mix of the avatar's sound field at surrounding points and interpolating these audio mixes for a predicted position of the avatar. To that end, an interpolation region may be defined based on the avatar's initial position. Then, full spatial-audio mixes may be sampled at various points around or within the interpolation region based on the sound field of the avatar at the first position. The audio mix generated based on the sampling of the interpolation region may be sent to the client device, which interpolates the mix based on a new position of the avatar. To interpolate the audio mix received from the network device, the client device may take a weighted average (or other statistical function) of the audio samples to obtain an approximate mix for the avatar's new location within the interpolation region. Thus, the client device may output audio that corresponds to the avatar's new position with a higher degree of accuracy, as compared to existing techniques.

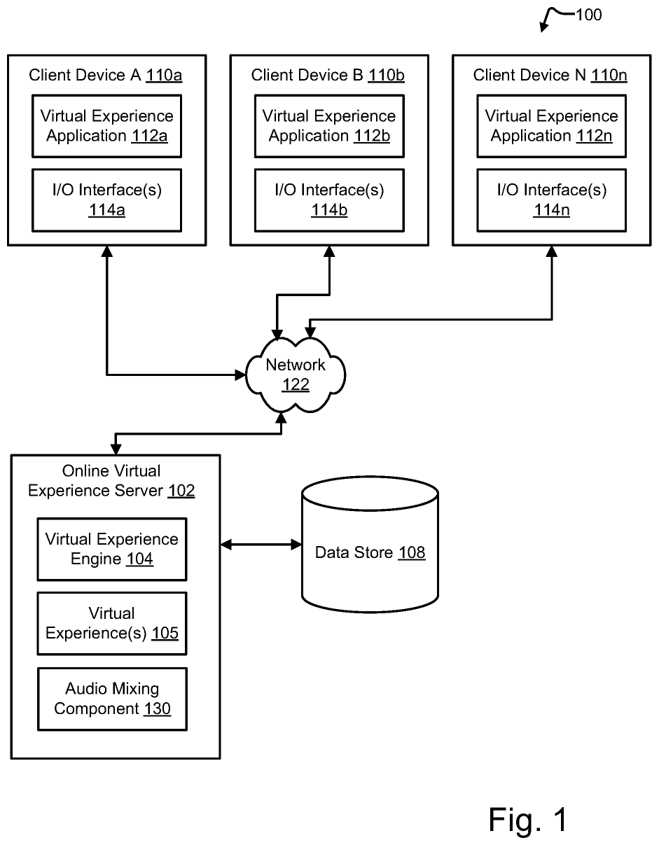

### FIG. 1: System Architecture

FIG. 1 illustrates an example network environment 100, in accordance with some implementations of the disclosure. FIG. 1 and the other figures use like reference numerals to identify like elements. A letter after a reference numeral, such as “110a,” indicates that the text refers specifically to the element having that particular reference numeral. A reference numeral in the text without a following letter, such as “110,” refers to any or all of the elements in the figures bearing that reference numeral (e.g., “110” in the text refers to reference numerals “110a,” “110b,” and/or “110n” in the figures).

The network environment 100 (also referred to as a “platform” herein) includes an online virtual-experience server 102, a data store 108, and a client device 110 (or multiple client devices), all connected via a network 122.

The online virtual-experience server 102 can include, among other things, a virtual-experience engine 104, one or more virtual experiences 105, and an audio-mixing component 130. The online virtual-experience server 102 may be configured to provide virtual experiences 105 to one or more client devices 110.

Data store 108 is shown coupled to online virtual-experience server 102 but in some implementations, can also be provided as part of the online virtual-experience server 102. The data store may, in some implementations, be configured to store advertising data, user data, engagement data, and/or other contextual data in association with the audio-mixing component 130. For example, data store 108 may store audio data associated with a sound field surrounding an avatar in a virtual experience 105. The sound field may include a plurality of audio channels emanating from various sound sources (e.g., other avatars, vehicles, advertisements, weather, animals, etc.). The avatar may be associated with the client device 110.

The client devices 110 (e.g., 110a, 110b, 110n) can include a virtual-experience application 112 (e.g., 112a, 112b, 112n) and an I/O interface 114 (e.g., 114a, 114b, 114n), to interact with the online virtual-experience server 102, and to view, for example, graphical user interfaces (GUI) through a computer monitor or display (not illustrated). In some implementations, the client devices 110 may be configured to execute and display virtual experiences, and output audio associated with sound fields of a player's avatar as it moves through the virtual experience 105, as described herein.

Network environment 100 is provided for illustration. In some implementations, the network environment 100 may include the same, fewer, more, or different elements configured in the same or different manner as that shown in FIG. 1.

In some implementations, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a Long Term Evolution (LTE) network), routers, hubs, switches, server computers, or a combination thereof.

In some implementations, the data store 108 may be a non-transitory computer readable memory (e.g., random access memory), a cache, a drive (e.g., a hard drive), a flash drive, a database system, or another type of component or device capable of storing data. The data store 108 may also include multiple storage components (e.g., multiple drives or multiple databases) that may also span multiple computing devices (e.g., multiple server computers).

In some implementations, the online virtual-experience server 102 can include a server having one or more computing devices (e.g., a cloud computing system, a rackmount server, a server computer, cluster of physical servers, virtual server, etc.). In some implementations, a server may be included in the online virtual-experience server 102, be an independent system, or be part of another system or platform. In some implementations, the online virtual-experience server 102 may be a single server, or any combination a plurality of servers, load balancers, network devices, and other components. The online virtual-experience server 102 may also be implemented on physical servers, but may utilize virtualization technology, in some implementations. Other variations of the online virtual-experience server 102 are also applicable.

In some implementations, the online virtual-experience server 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual-experience server 102 and to provide a user (e.g., user 114 via client device 110) with access to online virtual-experience server 102.

The online virtual-experience server 102 may also include a website (e.g., one or more web pages) or application back-end software that may be used to provide a user with access to content provided by online virtual-experience server 102. For example, users (or developers) may access online virtual-experience server 102 using the virtual-experience application 112 on client device 110, respectively.

In some implementations, online virtual-experience server 102 may include digital asset and digital virtual experience generation provisions. For example, the platform may provide administrator interfaces allowing the design, modification, unique tailoring for individuals, and other modification functions. In some implementations, virtual experiences may include two-dimensional (2D) games, three-dimensional (3D) games, virtual-reality (VR) games, or augmented-reality (AR) games, for example. In some implementations, virtual experience creators and/or developers may search for virtual experiences, combine portions of virtual experiences, tailor virtual experiences for particular activities (e.g., group virtual experiences), and other features provided through the online virtual-experience server 102.

In some implementations, online virtual-experience server 102 or client device 110 may include the virtual-experience engine 104 or virtual-experience application 112. In some implementations, virtual-experience engine 104 may be used for the development or execution of virtual experiences 105. For example, virtual-experience engine 104 may include a rendering engine (“renderer”) for 2D, 3D, VR, or AR graphics, a physics engine, a collision-detection engine (and collision response), sound engine, scripting functionality, haptics engine, artificial-intelligence engine, networking functionality, streaming functionality, memory-management functionality, threading functionality, scene-graph functionality, or video support for cinematics, among other features. The components of the virtual-experience engine 104 may generate commands that help compute and render the virtual experience (e.g., rendering commands, collision commands, physics commands, etc.).

The online virtual-experience server 102 using virtual-experience engine 104 may perform some or all the virtual-experience engine functions (e.g., generate physics commands, rendering commands, etc.), or offload some or all the virtual-experience engine functions to virtual-experience engine 104 of client device 110 (not illustrated). In some implementations, each virtual experience 105 may have a different ratio between the virtual-experience engine functions that are performed on the online virtual-experience server 102 and the virtual-experience engine functions that are performed on the client device 110.

In some implementations, virtual-experience instructions may refer to instructions that allow a client device 110 to render gameplay, graphics, and other features of a virtual experience. The instructions may include one or more of user input (e.g., physical object positioning), character position and velocity information, or commands (e.g., physics commands, rendering commands, collision commands, etc.).

In some implementations, the client device(s) 110 may each include computing devices such as personal computers (PCs), mobile devices (e.g., laptops, mobile phones, smart phones, tablet computers, or netbook computers), network-connected televisions, gaming consoles, etc. In some implementations, a client device 110 may also be referred to as a “user device.” In some implementations, one or more client devices 110 may connect to the online virtual-experience server 102 at any given moment. It may be noted that the number of client devices 110 is provided as illustration, rather than limitation. In some implementations, any number of client devices 110 may be used.

In some implementations, each client device 110 may include an instance of the virtual-experience application 112. The virtual-experience application 112 may be rendered for interaction at the client device 110. During user interaction within a virtual experience or another GUI of the online platform 100, audio of a sound field surrounding a listener's avatar may be output at the client device 110. For instance, the audio-mixing component 130 may sample an audio mix for an initial position or a predicted position of an avatar in a format that gives information about the surrounding sound field, in some implementations. Then, the client device 110 can use that information to evaluate an approximation of what the mix should sound like at the avatar's new position.

To that end, the audio-mixing component 130 may obtain audio data (also referred to herein as an “audio portion”) of a sound field of an avatar associated with client device 110. The sound field may be a region surrounding the avatar when it is located at an initial position in the virtual experience. The audio data of the sound field surrounding the avatar at its initial position may be captured at a first time. By way of example, the audio-mixing component 130 may obtain the audio data from the client device 110 and/or the data store 108. Based on the avatar's initial position, the audio-mixing component 130 may obtain samples of the audio mix at surrounding points of an interpolation region of the sound field.

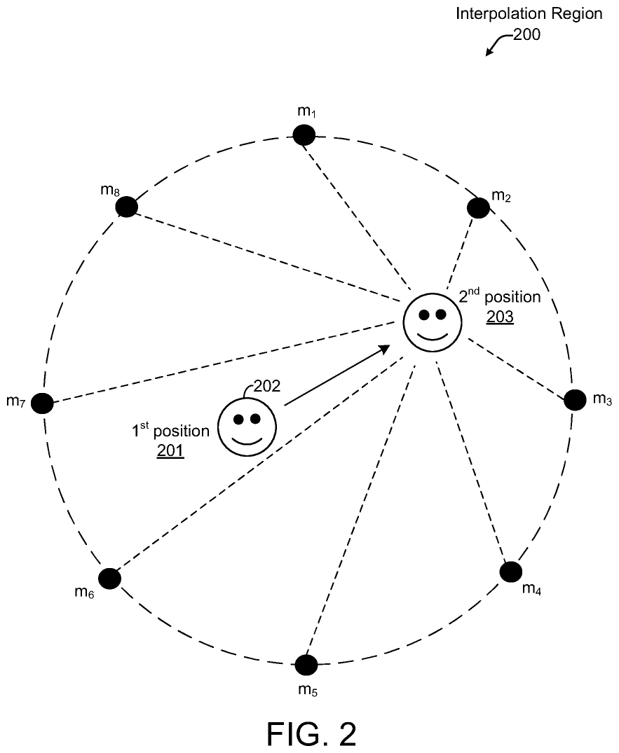

Hereinafter, a more detailed discussion of the audio-mixing component 130 is presented with reference to FIG. 2.

### FIG. 2: Interpolation Region

FIG. 2 is a schematic of an example visualization of an interpolation region 200 for use in audio mixing, in accordance with some implementations.

Referring to FIG. 2, the audio-mixing component 130 may define an interpolation region 200 based on an initial position (at 201) of an avatar 202 (e.g., a listener's avatar). The interpolation region 200 may encompass all or a portion of the sound field of the avatar 202 at a first position 201 (e.g., an initial position). That is, the interpolation region 200 may be used to define the audio channels used for approximating an audio mix for the avatar 202 at a second position 203 (e.g., a new position). Various techniques may be used to determine how to define the interpolation region 200.

In some implementations, the interpolation region 200 may be defined based solely on the initial position 201 of the avatar 202. In this case, which is not depicted in FIG. 2, the audio-mixing component 130 may define the interpolation region 200 as a sphere with a predetermined radius using the initial position 201 as the center point.

However, to determine the optimal position, orientation, and/or size for the interpolation region, the audio-mixing component 130 may take into account other factors, in some other implementations. These factors may include one or more of, e.g., avatar velocity, avatar angular velocity, avatar orientation, avatar density, sound-emitter orientation, and/or other factors. Using these other factors, the initial position 201 of the avatar 202 may or may not be the center point of the interpolation region 200. In some implementations, the interpolation region 200 may be defined using three-dimensional (3D) shapes other than a sphere.

Moreover, the scale of the interpolation region 200 may be selected based on various considerations. For instance, defining an interpolation region 200 of relatively small size may maximizing the accuracy of the sound field proximate to the new position 203 of the avatar 202. However, in some instances, if the audio-mixing component 130 defines the interpolation region 200 with an unduly small size, the problem of audio latency may occur when the avatar is moving fast enough to be located outside of the interpolation region 200 by the time the approximate mix reaches the client device 110. On the other hand, an interpolation region 200 of a comparatively large size may encompass a larger range of possible avatar motion. However, the accuracy of the approximated audio mix generated based on an interpolation region of large size may be reduced as compared to an interpolation region of a smaller size.

In some implementations, the audio-mixing component 130 may perform a geometry-aware selection to define the interpolation region 200. For example, if the first position 201 of the avatar 202 is located within an enclosed space (e.g., a home, a room, a building, a car, etc.), the interpolation region 200 may be defined such that it does not extend beyond the enclosure. This is because the sound emanating from outside of the enclosed space may be occluded and/or inaudible when the avatar 202 is located within the space.

In some implementations, the size of the interpolation region 200 may be dynamically defined based on a prediction of how far the avatar 200 will move by the time the audio mix reaches the client device 110.

Once the interpolation region 200 is defined, the audio-mixing component 130 may sample a first audio mix of the sound field of the avatar 202 at surrounding points m₁, m₂, m₃, . . . mᵢ. Each of these points mᵢ represents an entire mix at one listener position in some spatial audio format, e.g., such as stereo, quad, or ambisonics. Audio-mixing component 130 may generate an audio packet that includes the first audio mix of the sound field that includes all of the audio mixes mᵢ. The audio packet is transmitted over the network 122 to the client device 110.

The client device 110 may interpolate the first audio mix sampled for the plurality of points of the interpolation region 200 to obtain a second audio mix associated with the second position 203 of the avatar 202 in the virtual experience at the second time. To interpolate the first audio mixes, the client device 110 may perform a weighted average (or other statistical function(s) or the examples provided below) of the all of the audio mixes mᵢ to obtain an approximate mix for any location within the interpolation region 200. Thus, when the avatar 202 moves to the second position 203, the client device 110 may interpolate the first audio mix to obtain a second audio mix for the second position 203. The client device 110 may output audio associated with the second position 203 based on the second audio mix. In this way, audio may be output that corresponds to the second position 203 of the avatar 202 with a higher degree of accuracy, as compared to some other techniques.

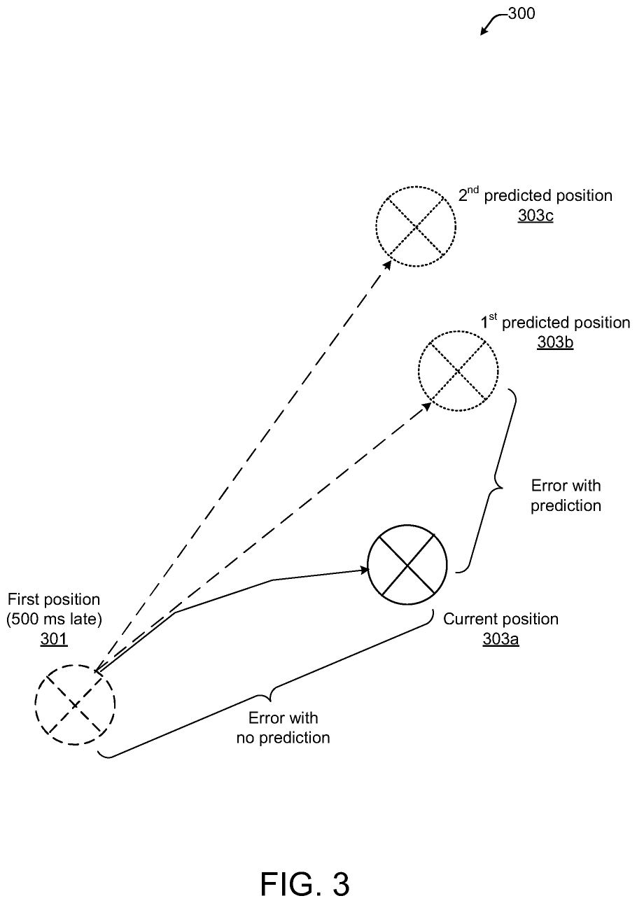

Various techniques to sample audio mixes for multiple predicted positions are discussed below with reference to FIG. 3.

### FIG. 3: Avatar-Location Prediction

FIG. 3 is a schematic of an example visualization of avatar-location prediction 300 for use in audio mixing, in accordance with some implementations.

Typically, the next few moves of a player's avatar 202 fall within a relatively discrete set, where it is likely the location of the avatar 202 in 500 ms can be predicted based upon probability within a tolerable error level. For instance, the audio-mixing component 130 may predict the avatar 202 to be at the first predicted position 303b or the second predicted position 303c, which are both different than the actual position 303a (e.g., the actual position of the avatar 202 in 500 ms).

To predict the position of the avatar 202 in 500 ms, the audio-mixing component 130 may employ various techniques. These techniques may include, e.g., dead-reckoning, input-based prediction, game logic-based prediction, game historical pattern prediction. Additionally and/or alternatively, the audio-mixing component 130 may use Kalmin filters, linear extrapolation, or machine-learning models to predict the position of the avatar 202 at the subsequent time (e.g., 500 ms). These algorithms can be separated into linear and non-linear algorithms. The prediction algorithms proposed only cover predicting fluid time series movements and are Realtime. Realtime (<500 ms) object-movement prediction for computing the audio mix at a “predicted” position in order to account for latency.

The application of predictors can solve the unique problem of accounting for latency between the online-virtual server 102 and the application of the audio mix at the client device 110. An example of a linear predictor is a predictor that keeps historical positions and velocity of the avatar 202, and uses the previous N samples to extrapolate the future samples by averaging the velocity and direction of the previous window to determine the first predicted position 303b and the second predicted position 303c. The audio-mixing component 130 may use various prediction strategies. For instance, the audio-mixing component 130 may use only one predictor to determine the first predicted position 303b and the second predicted position 303c. In some implementations, the audio-mixing component 130 may use multiple predicted positions, and generate different regional audio mixes for each predicted position. In some implementations, the audio-mixing component 130 may use multiple predicted positions, and interpolate between the different regional audio mixes to generate a single regional audio mix associate with each predicted position.

These predictors can result in multiple different regional audio mix collections. The preferred region can be selected by the client device 110. Each predicted location (e.g., a root predictor) from the above description corresponds to an entire region. If multiple predictors are used and the interpolation region selected is a sphere, multiple spheres will be mixed independently. Typically, the next few moves of a player fall within a relatively discrete set of movements, where it is likely the subsequent position of the avatar will be located within a tolerable error based upon probability. Each movement in the discrete set of movements can be classified in different categories, which can be exploited independently. For example, one category is first person, where the camera is the head of the avatar 202. Here, the movement is bound to the player object. Another category is follow mode. In follow mode the camera is bound in the direction in which the avatar 202 is moving. Therefore, movement is bound again to the avatar 202; however, the user may zoom in and out which adds another layer of complexity. Still another category is free mode. In free mode, the camera is bound to the avatar 202; however, the camera can travel in a sphere with a radius depending on zoom level.

Selecting between multiple predictions or relying on predictions can result in non-organic/smooth equations. Therefore, it may be a beneficial to interpolate between previous prediction positions to increase the accuracy prediction. In reality, the actual player driven movements are fluid motions and should be predicted accordingly. Predictions may not fit cleanly into a fluid motion, so they may be interpolated and smoothed across multiple predictions. This prediction mix interpolation smoothing may be performed by the audio-mixing component 130 or the client device 110. However, prediction interpolation may not be sufficient if the jump is large enough. Prediction interpolation may be performed in tandem with regional mixing interpolation.

Referring to FIG. 3, if the network latency between the start of when the audio mix is generated and when it is received by the client device 110 is 500 ms, the audio-mixing component 130 may predict positions for where the avatar 202 will be in 500 ms. In the non-limiting example depicted in FIG. 3, the audio-mixing component 130 predicts two predicted positions, e.g., namely first predicted position 303b and second predicted position 303c.

The audio-mixing component 130 may identify different interpolation regions for the different predicted positions. Referring to the example depicted in FIG. 3, the audio-mixing component 130 may identify a first interpolation region (not shown) for the first predicted position 303b and a second interpolation region (not shown) for the second predicted position 303c. The first and second interpolation regions may be defined using one or more of the techniques described herein.

The audio-mixing component 130 may sample a first regional audio mix for the first predicted position 303b using the first interpolation region and a second regional audio mix for the second predicted position 303c using the second interpolation region. In some implementations, the audio-mixing component 130 may generate an audio packet that includes the first regional audio mix and the second regional audio mix. The audio packet may also include an indication that the first regional audio mix corresponds to the first predicted position 303b and that the second regional audio mix corresponds to the second predicted position 303c. The audio packet may be transmitted to the client device 110 via the network 122.

The client device 110 may receive the audio packet that includes the first regional audio mix, the second regional audio mix, and information related to their respective correspondences the first predicted position 303b and the second predicted position 303. The client device 110 may determine the current position 303a of the avatar 202. The client device 110 may compare the first predicted position 303b and the second predicted position 303c to the actual position 202a to determine relative distances therebetween. Based on the comparison, the client device 110 may determine which predicted position is closest to the actual position 303a.

In the example depicted in FIG. 3, the first predicted position 303b is closest. In this instance, the client device 110 selects the first regional audio mix for interpolation. By interpolating the first regional audio mix, the client device 110 may obtain a second audio mix of the sound field of the actual position 303a of the avatar 202. However, in some other instances, the second predicted position 303c may be closest. Here, the client device 110 selects the second regional audio mix for interpolation. By interpolating the second regional audio mix, the client device 110 may obtain the second audio mix for the sound field of the actual position 303a.

In some implementations, the audio-mixing component 130 may interpolate between the first regional audio mix and the second regional audio mix to generate an interpolated regional audio mix associated with both predicted positions. Here, the audio packet that includes the interpolated regional audio mix may be generated and transmitted to the client device 110. The client device 110 may interpolate the interpolated regional audio mix based on the current position 303a to obtain the second audio mix, which is output to the user.

In this way, audio may be output that corresponds to the current position 303a of the avatar 202 with a higher degree of accuracy, as compared to some other techniques.

Interpolation refers to forming a new audio mix at a subsequent avatar position from a discrete set of mixes at other listener positions. Any audio mix will include a vector of audio samples (e.g., real numbers represented by integer or floating point values) indexed by time and audio channel. To perform interpolation, the client device 110 may use combinations of pre-existing interpolation methods such as, e.g., linear interpolation, quadratic interpolation, natural cubic-spline interpolation, Barycentric interpolation, and/or spherical interpolation.

In linear interpolation, the client device 110 may interpolate between points a and b by identifying a straight line between them. In quadradic interpolation, the client device 110 may interpolate between points a, b, and c by drawing a parabola between them. In natural cubic-spline interpolation, the client device 110 may interpolate between points a, b, and c by drawing a cubic spline between them with certain constraints for its derivatives at each point. In barycentric interpolation, the client device 110 may interpolate between points a, b, and c on a plane by taking a weighted average. In spherical interpolation, the client device 110 may interpolate between points by sines and cosines.

The client device 110 may perform interpolation using various region shapes (e.g., for taking sound samples). These region shapes may include, e.g., corners of a cube; corners, edges, centers, and core of a cube; corners and center of a cube; vertices and center of an octahedron; sphere with 4 equatorial points, 2 poles, and 1 center point; and sphere with 8 equatorial points, 2 poles, and 1 center point.

For a corners-of-a-cube region shape, if mix at each corner is treated as a weight, the client device may use standard trilinear interpolation to obtain a weighted average for any point inside the cube. The benefit of this region shape is that the average number of channels can be taken. The drawback of this region shape is the inaccuracy in the center, where the avatar 202 is most likely to be.

For corners, edges, centers, and core of a cube region shape, if 27 points are placed in a 3×3 cube pattern and the mix at each point is treat as a weight, the client device may use standard triquadratic interpolation to obtain a weighted average for any point inside the cube. Alternatively, instead of using quadratic functions, the client device 110 may use natural cubic splines to interpolate in a more stable way. The benefits of using this region shape is that cubic spline interpolation is stable and accounts for variation along the surface of the cube well. The drawbacks of using this region shape are the undue number of audio channels, and hence, computational complexity.

For corners and center of a cube region shape, this is similar to the previous scheme except the client device 110 obtains mix on the edge and center points implicitly by averaging adjacent corners. The client device 110 may interpolate using this scheme by first linearly interpolating across opposite faces, and then, interpolating along a line crossing the center of the cube using a natural cubic spline. The benefits of using this region shape is using an average number of channels, and the samples are directly left/right/front/back from avatar 202 provides optimal accuracy in those directions. The drawbacks of using this region shape is that linear interpolation along the faces of the cube may be unable to account for bell curves where the value at the center of the face should be much larger or smaller than the values at surrounding points.

For vertices-and-center-of-an-octahedron region shape, if 6 points may be placed in the shape of an axis-aligned octahedron surrounding the avatar 202, the client device 110 may interpolate across opposite triangular faces using barycentric coordinates and then interpolate along a line crossing the center of the octahedron using a natural cubic spline. The benefits of using this region shape include a limited number of audio channels, which reduces computational complexity, and the samples directly left/right/front/back from listener produces optimal accuracy in those directions. The drawbacks of using this region shape include that no samples in the diagonal directions loses accuracy in those directions, and linear interpolation along flat faces isn't optimal for constant-power panning.

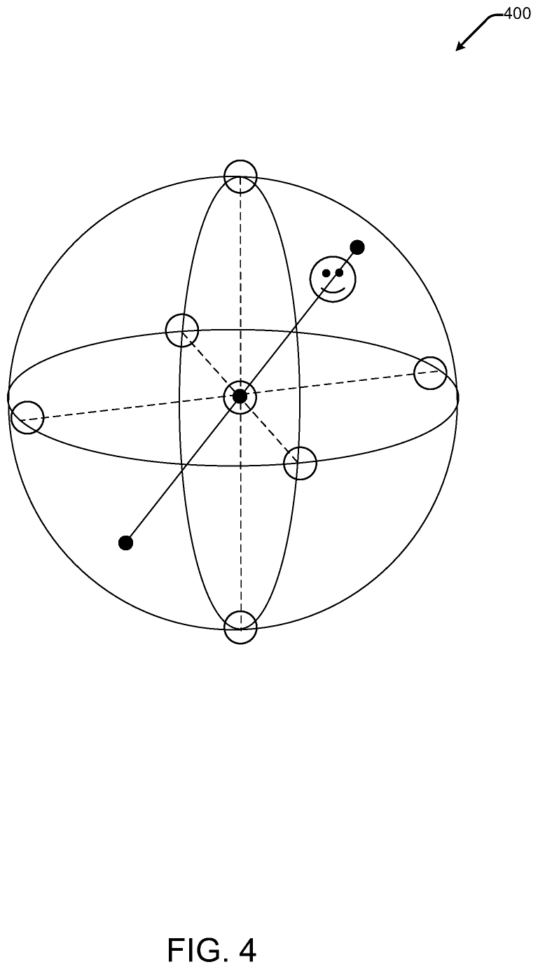

Referring to FIG. 4, for the sphere with 4 equatorial points, 2 poles, and 1 center point region shape 400, this is similar to the previous scheme except instead of using flat triangular faces, the audio-mixing component inflates the shape into a sphere and use spherical linear interpolation along opposite octents instead. The benefits of using this region shape include sampling fewer channels, which reduces computational complexity, and the spherical shape aligns well with roll-off shape, and the samples directly left/right/front/back from avatar 202 provide optimal accuracy in those directions. The drawbacks of this region shape include no samples in the diagonal directions, which loses accuracy in those directions.

For the sphere with 8 equatorial points, 2 poles, and 1 center point region shape, this region shape is similar to the previous scheme except instead of using 4 points along the equator, the client device 110 place 8, covering the diagonals. The benefits of using this region shape include that the spherical shape aligns well with roll-off shape, and many samples along the XZ plane provides optimal accuracy in those directions, which are the directions the player is most likely to be moving. The drawbacks of using this region shape include the large number of channels, which increase computational complexity.

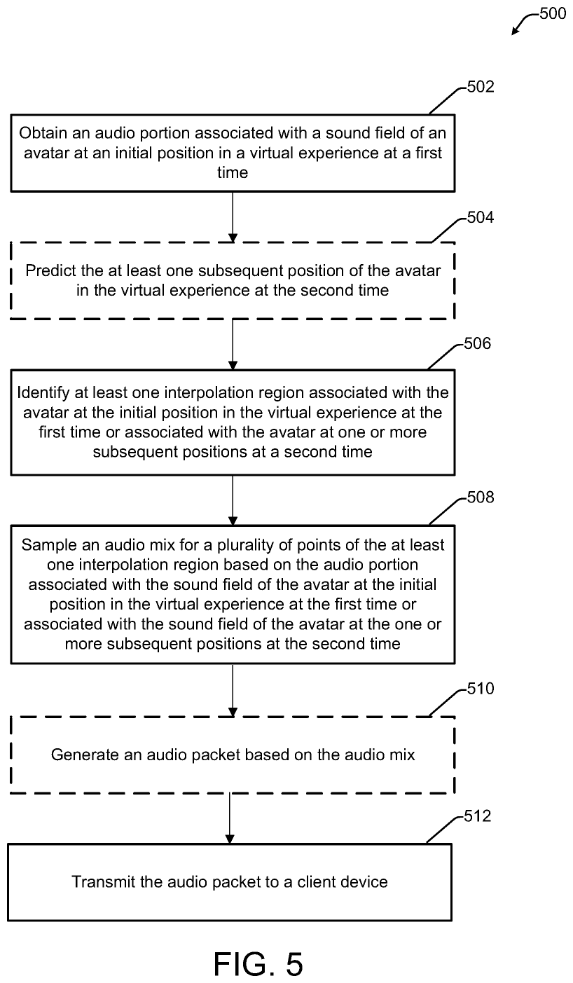

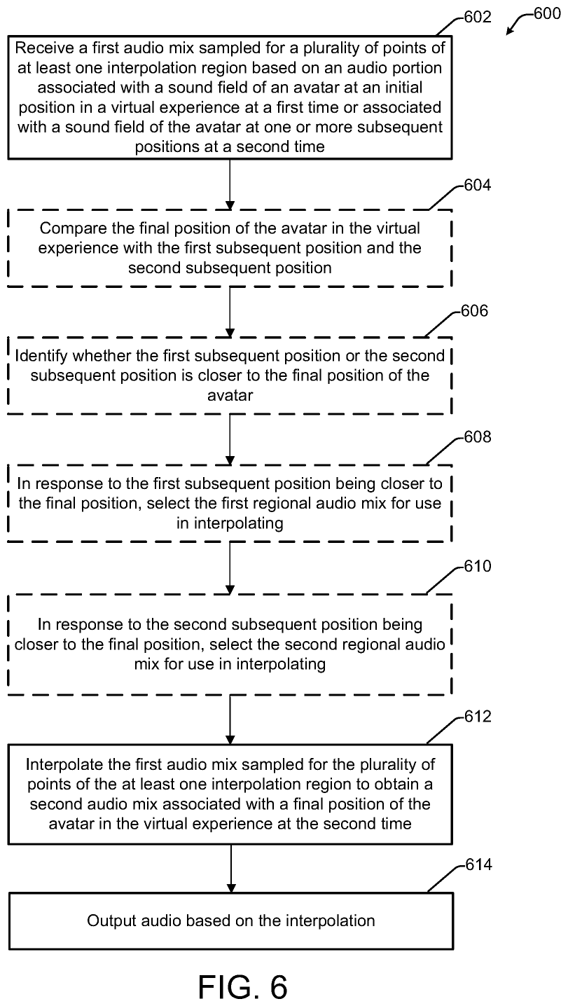

### FIGS. 5 and 6: Example Method(s) to Generate an Audio Mix

FIG. 5 is a flowchart of an example method 500 to generate an audio mix by a network device, in accordance with some implementations. FIG. 6 is a flowchart of an example method 600 to generate an audio mix by a client device, in accordance with some implementations.

In some implementations, methods 500 and 600 can be implemented, for example, on a server 102 and client device 110 described with reference to FIG. 1. In some implementations, some or all of the methods 500, 600 can be implemented on one or more client devices 110 as shown in FIG. 1, on one or more developer devices (not illustrated), or on one or more server device(s) 102, and/or on a combination of developer device(s), server device(s) and client device(s). In described examples, the implementing system includes one or more digital processors or processing circuitry (“processors”), and one or more storage devices (e.g., a data store 108 or other storage). In some implementations, different components of one or more servers and/or clients can perform different blocks or other parts of the methods 500 and 600. Some implementations can have one or more blocks of methods 500 and 600 performed by one or more other devices (e.g., other client devices or server devices) that can send results or data to the first device. In FIGS. 5 and 6, optional operations may be indicated with dashed lines.

Referring to FIG. 5, at block 502, the network device may obtain an audio portion associated with a sound field of an avatar at an initial position in a virtual experience at a first time. For example, referring to FIG. 1, audio-mixing component 130 may obtain an audio portion from data store 108. The audio portion may be associated with a sound field of an avatar in a virtual experience at a first time. The avatar may be associated with client device 110. Block 502 may be followed by block 504.

At block 504, the network device may predict the at least one subsequent position of the avatar in the virtual experience at the second time. For example, referring to FIG. 3, if the network latency between the start of when the audio mix is generated and when it is received by the client device 110 is 500 ms, the audio-mixing component 130 may predict positions for where the avatar 202 will be in 500 ms. In the non-limiting example depicted in FIG. 3, the audio-mixing component 130 predicts two predicted positions, e.g., namely first predicted position 303b and second predicted position 303c. The prediction may be performed using one or more of the techniques described above. Block 504 may be followed by block 506.

At block 506, the network device may identify at least one interpolation region associated with the avatar at the initial position in the virtual experience at the first time or associated with the avatar at one or more subsequent positions at a second time. For example, referring to FIG. 2, the audio-mixing component 130 may define an interpolation region 200 based on an initial position (at 201) of an avatar 202 (e.g., a listener's avatar). The interpolation region 200 may encompass all or a portion of the sound field of the avatar 202 at a first position 201 (e.g., an initial position). That is, the interpolation region 200 may be used to define the audio channels used for approximating an audio mix for the avatar 202 at a second position 203 (e.g., a new position). Various techniques may be used to determine how to define the interpolation region 200. Referring to FIG. 3, the audio-mixing component 130 may identify different interpolation regions for the different predicted positions. Referring to the example depicted in FIG. 3, the audio-mixing component 130 may identify a first interpolation region (not shown) for the first predicted position 303b and a second interpolation region (not shown) for the second predicted position 303c. The first and second interpolation regions may be defined using one or more of the techniques described herein. Block 506 may be followed by block 508.

At block 508, the network device may sample an audio mix for a plurality of points of the at least one interpolation region based on the audio portion associated with the sound field of the avatar at the initial position in the virtual experience at the first time or associated with the sound field of the avatar at the one or more subsequent positions at the second time. For example, referring to FIG. 2, once the interpolation region 200 is defined, the audio-mixing component 130 may sample a first audio mix of the sound field of the avatar 202 at surrounding points m₁, m₂, m₃, . . . mᵢ. Each of these points mᵢ represents an entire mix at one listener position in some spatial audio format, e.g., such as stereo, quad, or ambisonics. Referring to FIG. 3, the audio-mixing component 130 may sample a first regional audio mix for the first predicted position 303b using the first interpolation region and a second regional audio mix for the second predicted position 303c using the second interpolation region. Block 508 may be followed by block 510.

At block 510, the network device may generate an audio packet based on the audio mix. For example, referring to FIG. 2, audio-mixing component 130 may generate an audio packet that includes the first audio mix of the sound field that includes all of the audio mixes mᵢ. Referring to FIG. 3, the audio-mixing component 130 may generate an audio packet that includes the first regional audio mix and the second regional audio mix. The audio packet may also include an indication that the first regional audio mix corresponds to the first predicted position 303b and that the second regional audio mix corresponds to the second predicted position 303c. In some implementations, the audio-mixing component 130 may interpolate between the first regional audio mix and the second regional audio mix to generate an interpolated regional audio mix associated with both predicted positions. Here, the audio packet that includes the interpolated regional audio mix may be generated and transmitted to the client device 110. Block 510 may be followed by block 512.

At block 512, the network device may transmit the audio packet to a client device. For example, referring to FIGS. 2 and 3, the audio-mixing component 130 may transmit the audio packet to the client device 110 via the network 122. Block 512 may conclude the operations of FIG. 5.

Referring to FIG. 6, at block 602, the client device may receive a first audio mix sampled for a plurality of points of at least one interpolation region based on an audio portion associated with a sound field of an avatar at an initial position in a virtual experience at a first time or associated with a sound field of the avatar at one or more subsequent positions at a second time. For example, referring to FIG. 2, the client device 110 may receive an audio packet that includes the first audio mix of the sound field that includes all of the audio mixes mᵢ. Referring to FIG. 3, the client device 110 may receive an audio packet that includes the first regional audio mix and the second regional audio mix. The audio packet may also include an indication that the first regional audio mix corresponds to the first predicted position 303b and that the second regional audio mix corresponds to the second predicted position 303c. In some implementations, the audio packet may include an interpolated regional audio mix associated with both predicted positions. Block 602 may be followed by block 604.

At block 604, the client device may compare the final position of the avatar in the virtual experience with the first subsequent position and the second subsequent position. For example, referring to FIG. 3, the client device 110 may determine the current position 303a of the avatar 202. The client device 110 may compare the first predicted position 303b and the second predicted position 303c to the actual position 202a to determine relative distances therebetween.

At block 606, the client device may identify whether the first subsequent position or the second subsequent position is closer to the final position of the avatar. For example, referring to FIG. 3, based on the comparison, the client device 110 may determine which predicted position is closest to the actual position 303a. Block 604 may be followed by block 606. Block 606 may be followed by block 608.

At block 608, in response to the first subsequent position being closer to the final position, the client device may select the first regional audio mix for use in interpolating. For example, referring to FIG. 3, the first predicted position 303b is closest. In this instance, the client device 110 selects the first regional audio mix for interpolation. Block 608 may be followed by block 610.

At block 610, in response to the second subsequent position being closer to the final position, the client device may select the second regional audio mix for use in interpolating. For example, referring to FIG. 3, the second predicted position 303c may be closest. Here, the client device 110 selects the second regional audio mix for interpolation. Block 610 may be followed by block 612.

At block 612, the client device may interpolate the first audio mix sampled for the plurality of points of the at least one interpolation region to obtain a second audio mix associated with a final position of the avatar in the virtual experience at the second time. For example, referring to FIG. 2, the client device 110 may interpolate the first audio mix sampled for the plurality of points of the interpolation region 200 to obtain a second audio mix associated with the second position 203 of the avatar 202 in the virtual experience at the second time. To interpolate the first audio mixes, the client device 110 may perform a weighted average (or other statistical function(s) or the examples provided below) of the all of the audio mixes mᵢ to obtain an approximate mix for any location within the interpolation region 200. Thus, when the avatar 202 moves to the second position 203, the client device 110 may interpolate the first audio mix to obtain a second audio mix for the second position 203. Referring to FIG. 3, by interpolating the first regional audio mix, the client device 110 may obtain a second audio mix of the sound field of the actual position 303a of the avatar 202. In some implementations, by interpolating the second regional audio mix, the client device 110 may obtain the second audio mix for the sound field of the actual position 303a. In some other implementations, the client device 110 may interpolate the interpolated regional audio mix to obtain the second audio mix for the sound field of the actual position 303a. Block 612 may be followed by block 614.

At block 614, the client device may output audio based on the interpolation. For example, referring to FIGS. 2 and 3, the client device 110 may output audio associated with the second audio sample. Block 614 may conclude the operations of FIG. 6.

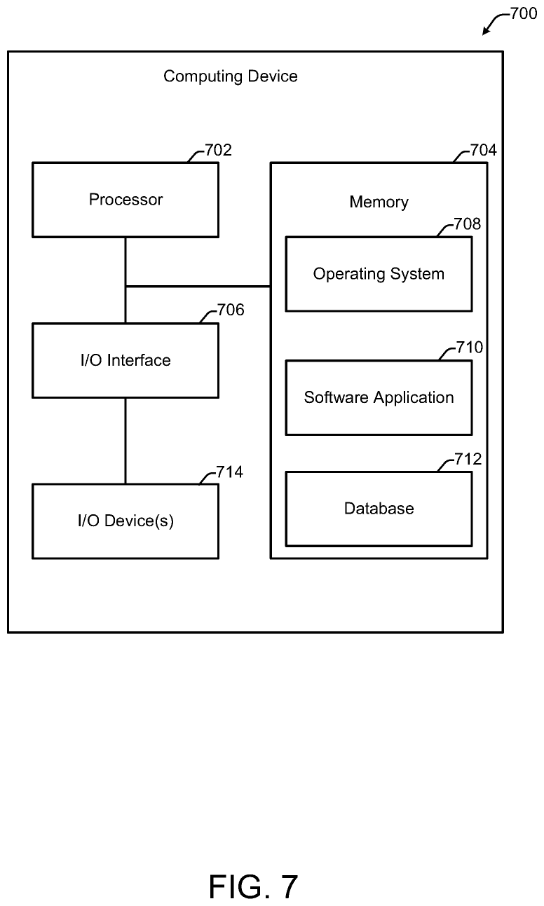

### FIG. 7: Computing Devices

Hereinafter, a more detailed description of various computing devices that may be used to implement different devices and/or components illustrated in FIG. 1 is provided with reference to FIG. 7.

FIG. 7 is a block diagram of an example computing device 700 which may be used to implement one or more features described herein, in accordance with some implementations. In one example, device 700 may be used to implement a computer device, (e.g., 102, 110 of FIG. 1), and perform appropriate operations as described herein. Computing device 700 can be any suitable computer system, server, or other electronic or hardware device. For example, the computing device 700 can be a mainframe computer, desktop computer, workstation, portable computer, or electronic device (portable device, mobile device, cell phone, smart phone, tablet computer, television, TV set top box, personal digital assistant (PDA), media player, game device, wearable device, etc.). In some implementations, device 700 includes a processor 702, a memory 704, input/output (I/O) interface 706, and audio/video input/output devices 714 (e.g., display screen, touchscreen, display goggles or glasses, audio speakers, headphones, microphone, etc.).

Processor 702 can be one or more processors and/or processing circuits to execute program code and control basic operations of the device 700. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 704 is typically provided in device 700 for access by the processor 702, and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 702 and/or integrated therewith. Memory 704 can store software operating on the server device 700 by the processor 702, including an operating system 708, software application 710 and associated data 712. In some implementations, the applications 710 can include instructions that enable processor 702 to perform the functions described herein. Software application 710 may include some or all of the functionality required to generate audio mixes. In some implementations, one or more portions of software application 710 may be implemented in dedicated hardware such as an application-specific integrated circuit (ASIC), a programmable logic device (PLD), a field-programmable gate array (FPGA), a machine learning processor, etc. In some implementations, one or more portions of software application 710 may be implemented in general purpose processors, such as a central processing unit (CPU) or a graphics processing unit (GPU). In various implementations, suitable combinations of dedicated and/or general purpose processing hardware may be used to implement software application 710.

For example, software application 710 stored in memory 704 can include instructions for retrieving historical movement data or audio channels. Any of software in memory 704 can alternatively be stored on any other suitable storage location or computer-readable medium. In addition, memory 704 (and/or other connected storage device(s)) can store instructions and data used in the features described herein. Memory 704 and any other type of storage (magnetic disk, optical disk, magnetic tape, or other tangible media) can be considered “storage” or “storage devices.”

I/O interface 706 can provide functions to enable interfacing the server device 700 with other systems and devices. For example, network communication devices, storage devices (e.g., memory and/or data store 106), and input/output devices can communicate via interface 706. In some implementations, the I/O interface can connect to interface devices including input devices (keyboard, pointing device, touchscreen, microphone, camera, scanner, etc.) and/or output devices (display device, speaker devices, printer, motor, etc.).

For ease of illustration, FIG. 7 shows one block for each of processor 702, memory 704, I/O interface 706, software blocks 708 and 710, and database 712. These blocks may represent one or more processors or processing circuitries, operating systems, memories, I/O interfaces, applications, and/or software modules. In other implementations, device 700 may not have all of the components shown and/or may have other elements including other types of elements instead of, or in addition to, those shown herein. While the online server 102 are described as performing operations as described in some implementations herein, any suitable component or combination of components of online server 102, or similar system, or any suitable processor or processors associated with such a system, may perform the operations described.

A user device can also be implemented and/or be used with features described herein. Example user devices can be computer devices including some similar components as the device 700, e.g., processor(s) 702, memory 704, and I/O interface 706. An operating system, software and applications suitable for the client device can be provided in memory and used by the processor. The I/O interface for a client device can be connected to network communication devices, as well as to input and output devices, e.g., a microphone for capturing sound, a camera for capturing images or video, audio speaker devices for outputting sound, a display device for outputting images or video, or other output devices. A display device within the audio/video input/output devices 714, for example, can be connected to (or included in) the device 700 to display images pre- and post-processing as described herein, where such display device can include any suitable display device, e.g., an LCD, LED, or plasma display screen, CRT, television, monitor, touchscreen, 3-D display screen, projector, or other visual display device. Some implementations can provide an audio output device, e.g., voice output or synthesis that speaks text.

The methods, blocks, and/or operations described herein can be performed in a different order than shown or described, and/or performed simultaneously (partially or completely) with other blocks or operations, where appropriate. Some blocks or operations can be performed for one portion of data and later performed again, e.g., for another portion of data. Not all of the described blocks and operations need be performed in various implementations. In some implementations, blocks and operations can be performed multiple times, in a different order, and/or at different times in the methods.

In some implementations, some or all of the methods can be implemented on a system such as one or more client devices. In some implementations, one or more methods described herein can be implemented, for example, on a server system, and/or on both a server system and a client system. In some implementations, different components of one or more servers and/or clients can perform different blocks, operations, or other parts of the methods.

One or more methods described herein (e.g., method 500, 600) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g. Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

One or more methods described herein can be run in a standalone program that can be run on any type of computing device, a program run on a web browser, a mobile application (“app”) executing on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the live feedback data for output (e.g., for display). In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A method of audio-signal processing by a network device, comprising:
obtaining, by a processor of the network device, an audio portion associated with a sound field of an avatar at an initial position in a virtual experience at a first time;
identifying, by the processor, at least one interpolation region associated with the avatar at the initial position in the virtual experience at the first time or associated with the avatar at one or more subsequent positions at a second time, the second time being later than the first time;
sampling, by the processor, an audio mix for a plurality of points of the at least one interpolation region based on the audio portion associated with the sound field of the avatar at the initial position in the virtual experience at the first time or associated with the sound field of the avatar at the one or more subsequent positions at the second time; and
transmitting, by the processor, an audio packet associated with the audio mix to a client device.

2. The method of claim 1, further comprising:
predicting, by the processor, the one or more subsequent positions of the avatar in the virtual experience at the second time.

3. The method of claim 2, wherein predicting the one or more subsequent positions of the avatar is performed based on at least one of:
a dead-reckoning operation, an input-based prediction operation, a game-logic based operation, a Kalman filter, a linear extrapolation, or a machine-learning model.

4. The method of claim 2, wherein:
the one or more subsequent positions includes a first subsequent position and a second subsequent position both associated with the second time, and
the at least one interpolation region includes a first interpolation region associated with the first subsequent position and a second interpolation region associated with the second subsequent position.

5. The method of claim 4, wherein sampling the audio mix for the plurality of points of the interpolation region based on the audio portion associated with the sound field of the avatar at the initial position in the virtual experience at the first time or associated with the sound field of the avatar at the one or more subsequent positions at the second time comprises:
sampling, by the processor, a first regional audio mix for the plurality of points based the first interpolation region associated with the first subsequent position; and
sampling, by the processor, a second regional audio mix for the plurality of points based on the second interpolation region associated with the second subsequent position.

6. The method of claim 5, wherein:
the first regional audio mix includes a first plurality of audio channels associated with the first subsequent position, and
the second regional audio mix includes a second plurality of audio channels associated with the second subsequent position.

7. The method of claim 5, further comprising:
generating, by the processor, the audio packet based on the first regional audio mix and the second regional audio mix.

8. A non-transitory computer-readable medium storing instructions, which when executed by a processor of a network device, cause the processor to perform operations comprising:
obtaining an audio portion associated with a sound field of an avatar at an initial position in a virtual experience at a first time;
identifying at least one interpolation region associated with the avatar at the initial position in the virtual experience at the first time or associated with the avatar at one or more subsequent positions at a second time, the second time being later than the first time;
sampling an audio mix for a plurality of points of the at least one interpolation region based on the audio portion associated with the sound field of the avatar at the initial position in the virtual experience at the first time or associated with the sound field of the avatar at the one or more subsequent positions at the second time; and
transmitting an audio packet associated with the audio mix to a client device.

9. The non-transitory computer-readable medium of claim 8, wherein the operations further comprise:
predicting the one or more subsequent positions of the avatar in the virtual experience at the second time.

10. The non-transitory computer-readable medium of claim 9, wherein predicting the one or more subsequent positions of the avatar is performed based on at least one of:
a dead-reckoning operation, an input-based prediction operation, a game-logic based operation, a Kalman filter, a linear extrapolation, or a machine-learning model.

11. The non-transitory computer-readable medium of claim 9, wherein:
the one or more subsequent positions includes a first subsequent position and a second subsequent position both associated with the second time, and
the at least one interpolation region includes a first interpolation region associated with the first subsequent position and a second interpolation region associated with the second subsequent position.

12. The non-transitory computer-readable medium of claim 11, wherein sampling the audio mix for the plurality of points of the interpolation region based on the audio portion associated with the sound field of the avatar at the initial position in the virtual experience at the first time or associated with the sound field of the avatar at the one or more subsequent positions at the second time comprises:
sampling a first regional audio mix for the plurality of points based the first interpolation region associated with the first subsequent position; and
sampling a second regional audio mix for the plurality of points based on the second interpolation region associated with the second subsequent position.

13. The non-transitory computer-readable medium of claim 12, wherein:
the first regional audio mix includes a first plurality of audio channels associated with the first subsequent position, and
the second regional audio mix includes a second plurality of audio channels associated with the second subsequent position.

14. The non-transitory computer-readable medium of claim 12, wherein the operations further comprise:
generating the audio packet based on the first regional audio mix and the second regional audio mix.

15. A system for audio-signal processing of a network device, comprising:
a processor; and
a memory coupled to the processor and storing instructions, which when executed by the processor, cause the processor to perform operations comprising:
obtaining an audio portion associated with a sound field of an avatar at an initial position in a virtual experience at a first time;
identifying at least one interpolation region associated with the avatar at the initial position in the virtual experience at the first time or associated with the avatar at one or more subsequent positions at a second time, the second time being later than the first time;
sampling an audio mix for a plurality of points of the at least one interpolation region based on the audio portion associated with the sound field of the avatar at the initial position in the virtual experience at the first time or associated with the sound field of the avatar at the one or more subsequent positions at the second time; and
transmitting an audio packet associated with the audio mix to a client device.

16. The system of claim 15, wherein the operations further comprise:
predicting the one or more subsequent positions of the avatar in the virtual experience at the second time.

17. The system of claim 16, wherein predicting the one or more subsequent positions of the avatar is performed based on at least one of:
a dead-reckoning operation, an input-based prediction operation, a game-logic based operation, a Kalman filter, a linear extrapolation, or a machine-learning model.

18. The system of claim 16, wherein:
the one or more subsequent positions includes a first subsequent position and a second subsequent position both associated with the second time, and
the at least one interpolation region includes a first interpolation region associated with the first subsequent position and a second interpolation region associated with the second subsequent position.

19. The system of claim 18, wherein sampling the audio mix for the plurality of points of the interpolation region based on the audio portion associated with the sound field of the avatar at the initial position in the virtual experience at the first time or associated with the sound field of the avatar at the one or more subsequent positions at the second time comprises:
sampling a first regional audio mix for the plurality of points based the first interpolation region associated with the first subsequent position; and
sampling a second regional audio mix for the plurality of points based on the second interpolation region associated with the second subsequent position.

20. The system of claim 19, wherein:
the first regional audio mix includes a first plurality of audio channels associated with the first subsequent position, and
the second regional audio mix includes a second plurality of audio channels associated with the second subsequent position.
